(19) United States
(12) Patent Application Publication
(10) Pub. No.: US 2025/0214048 A1
(43) Pub. Date: Jul. 3, 2025

(54) APPARATUS FOR DRIVING A VERTICAL MOTION MIXER

(71) Applicant: ENERSAVE FLUID MIXERS INC., Oakville (CA)

(72) Inventors: Gary HAUGHTON, Oakville (CA); Alesandro ROSADA, Toronto (CA)

(21) Appl. No.: 19/068,936

(22) Filed: Mar. 3, 2025

Related U.S. Application Data
(60) Provisional application No. 63/617,250, filed on Jan. 3, 2024.

(51) Int. Cl. B01F 35/32; B01F 35/30; F16H 37/16

(52) U.S. Cl. CPC B01F 35/323; B01F 35/3204; B01F 35/3215; F16H 37/16; B01F 2035/352

(57) ABSTRACT

The apparatus comprises: an assembly defining a drive axis, a translation axis perpendicular to the drive axis and an offset axis perpendicular to both the drive and translation axes, the assembly including a yoke; a shuttle mounted to the yoke for reciprocating motion along the yoke parallel to the translation axis; and a pair of drive mechanisms spaced apart from one another in the direction of the offset axis and disposed in flanking relation to the yoke, each drive mechanism including a body that follows a closed loop, said body being operatively coupled to the shuttle to reciprocate the yoke along a path parallel to the drive axis.

### CROSS-REFERENCE TO RELATED APPLICATIONS

This application claims priority to, and incorporates by reference, U.S. Provisional Patent Application Ser. No. 63/617,250, filed Jan. 3, 2024.

### FIELD

The invention relates to the field of vertical motion mixers

### BACKGROUND

Vertical motion mixers are known to provide mixing functionality at relatively low energy consumption. However, it can be difficult to manufacture known vertical motion mixtures with a reasonable level of reliability at a reasonable cost.

### SUMMARY OF THE INVENTION

Forming one aspect of the invention is apparatus comprising: an assembly defining a drive axis, a translation axis perpendicular to the drive axis and an offset axis perpendicular to both the drive and translation axes, the means including a yoke; a shuttle mounted to the yoke for reciprocating motion along the yoke parallel to the translation axis; and a pair of drive mechanisms spaced apart from one another in the direction of the offset axis and disposed in flanking relation to the yoke, each drive mechanism including a body that follows a closed loop, said body being operatively coupled to the shuttle to reciprocate the yoke along a path parallel to the drive axis.

Advantages, features and characteristics will become evident upon a review of the following detailed description, with reference to the appended drawings, the latter being briefly described hereinafter.

### BRIEF DESCRIPTION OF THE DRAWINGS

In the drawings:

FIG. 1 is a perspective view of apparatus according to an example embodiment of the invention;

FIG. 2 is a view similar to FIG. 1 but with side posts removed, for clarity;

FIG. 3 is an exploded view of the structure of FIG. 1;

FIG. 4 is an enlarged view of a portion of FIG. 3 indicated by general reference numeral 4

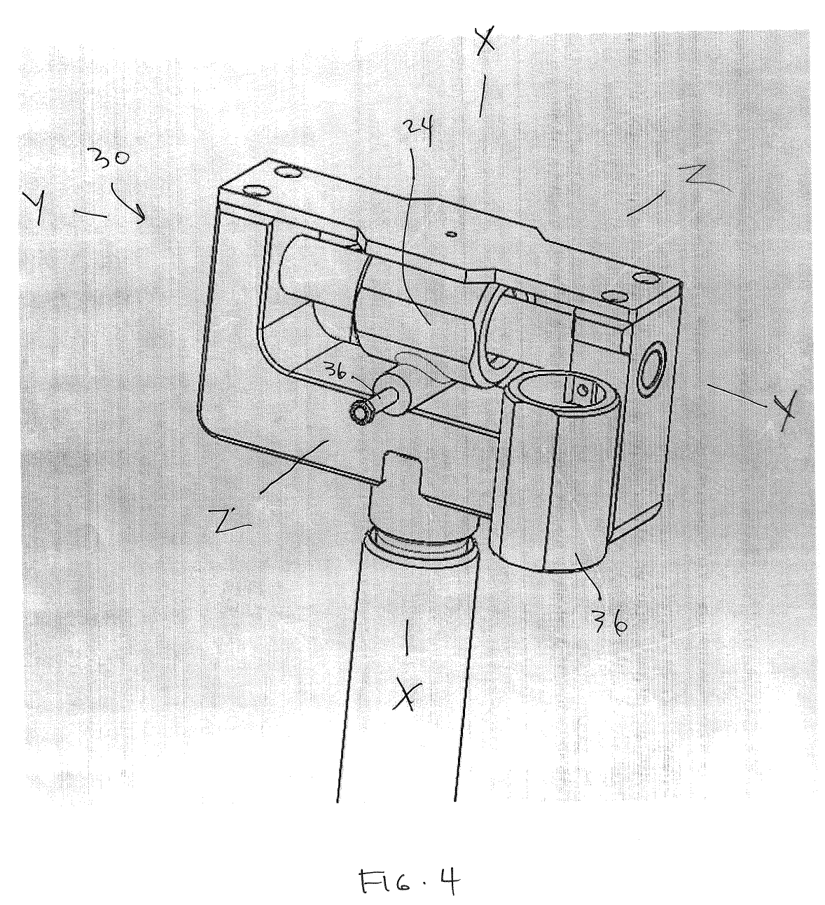

FIG. 5 is a cross-sectional view of a portion of FIG. 2 indicated by general reference numeral 5

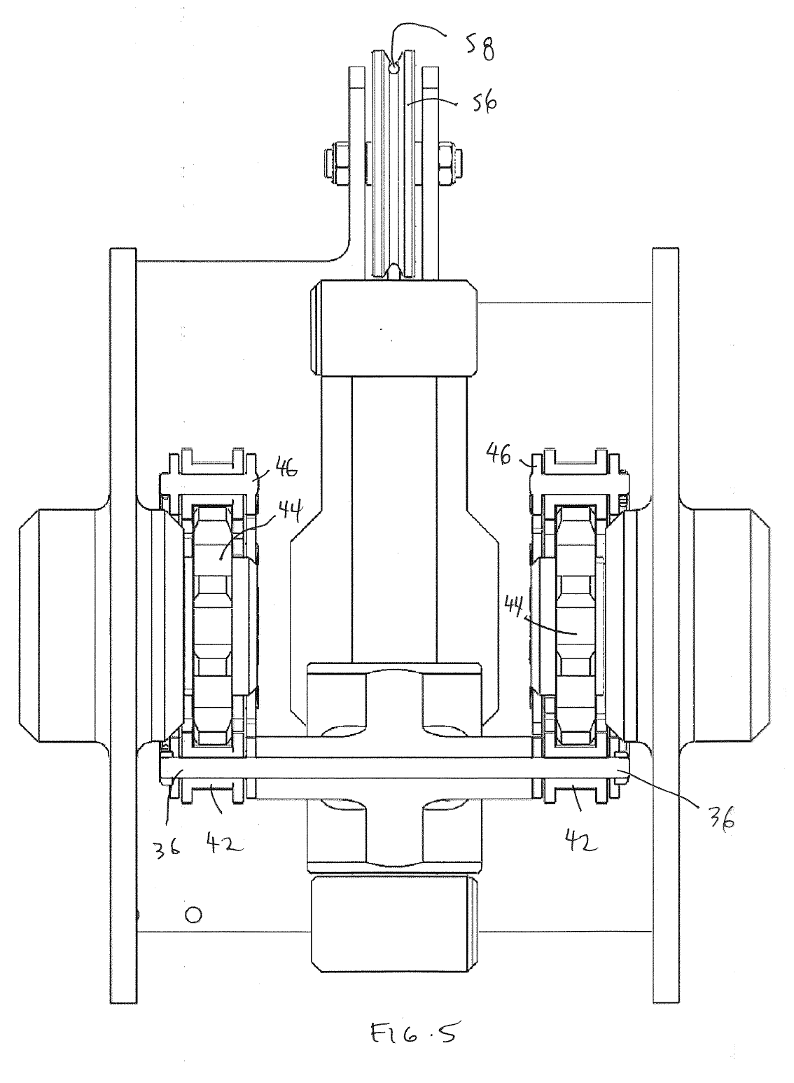

FIG. 6 is a view, similar to FIG. 1, but with both side posts and one half of the gearing removed, for clarity, the body being at top dead centre;

FIG. 7 is a view similar to FIG. 6, but with the body approximately ⅓ through a cycle;

FIG. 8 is a view similar to FIG. 6, but with the body at bottom dead centre; and

FIG. 9 is a view similar to FIG. 6, with the body approximately ⅔ through the cycle.

### DETAILED DESCRIPTION

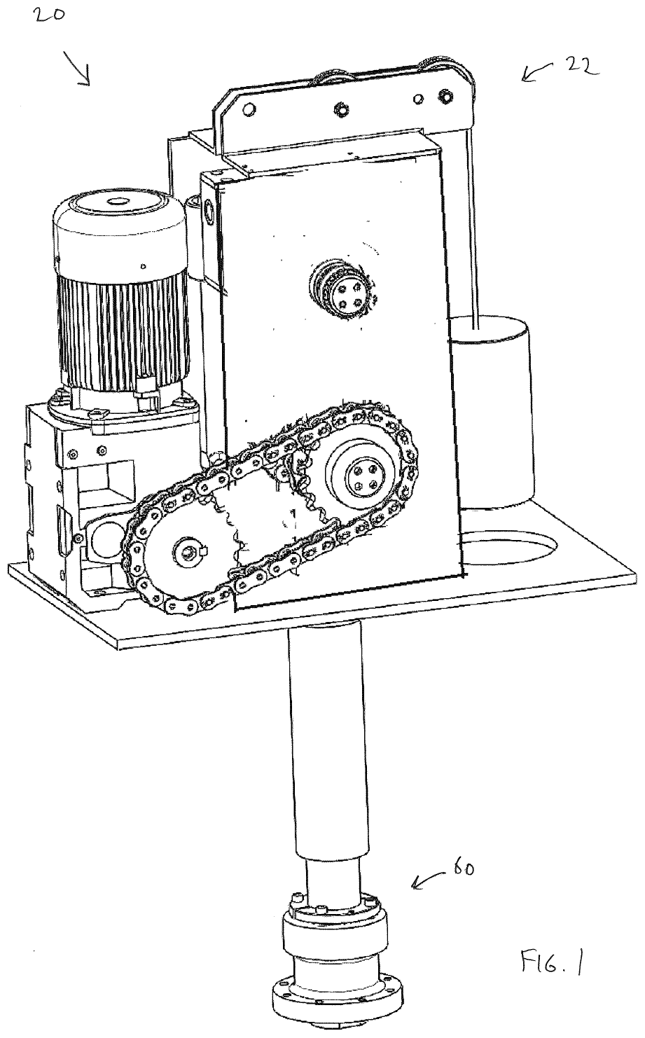

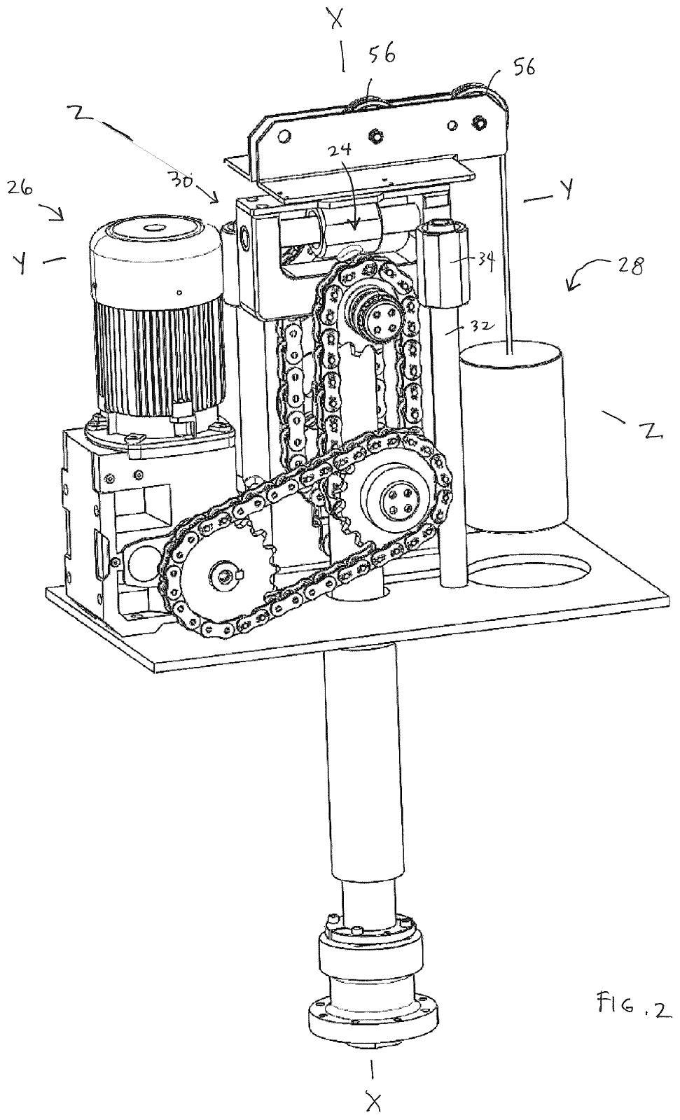

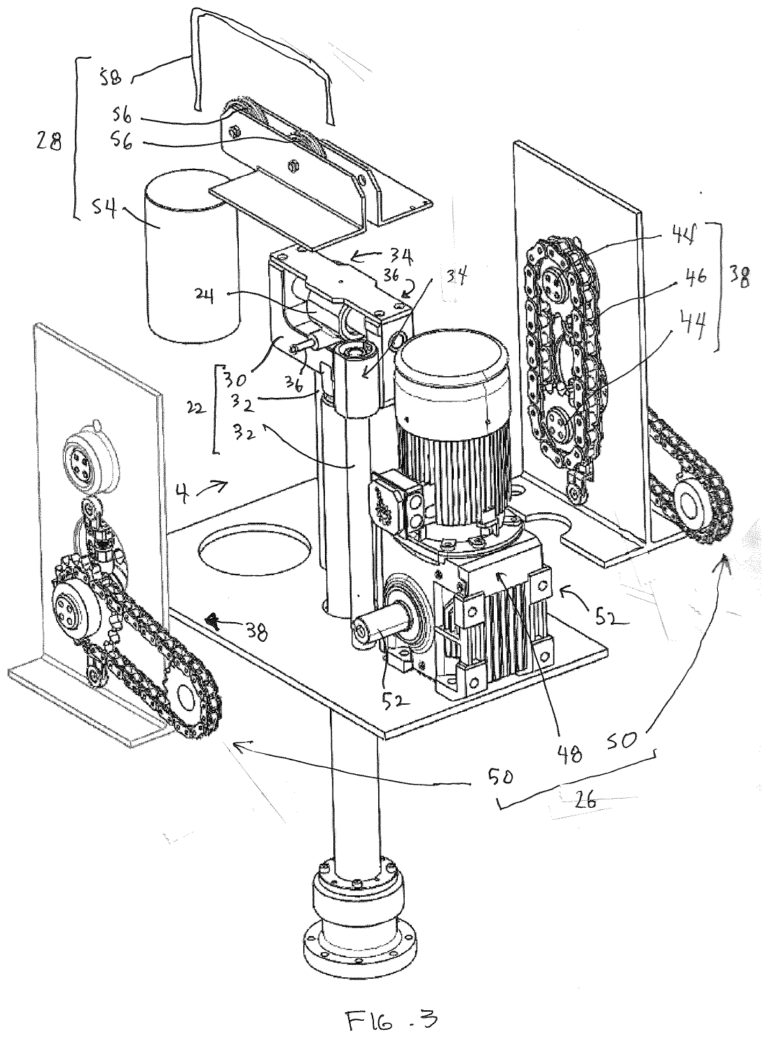

An example embodiment of the invention is shown in FIG. 1 and indicated by general reference numeral 20. The same embodiment is shown in exploded view in FIG. 3, and, for clarity, with side posts removed in FIG. 2

The apparatus 20 will be understood to generally comprise an assembly 22, a shuttle 24, a pair of drive mechanisms 38, a motor arrangement 26 and a counterweight arrangement 28.

The assembly 22 defines a drive axis X-X, a translation axis Y-Y perpendicular to the drive axis and an offset axis Z-Z perpendicular to both the drive and translation axes and includes a yoke 30 and a pair of bearing shafts 32 disposed in parallel flanking spaced relation to the path. The yoke 30 defines, for each shaft 32, a bushing 34, said bushing 34 being in receipt of said each shaft 32.

The shuttle 24 is a bushing mounted to the yoke 30 for reciprocating motion along the yoke 30 parallel to the translation axis and terminates in a pair of pintles 36 extending from opposite ends, spaced apart from one another in a direction parallel to the offset axis and extending in the direction of the offset axis.

The drive mechanisms 38 are spaced apart from one another in the direction of the offset axis and disposed in flanking relation to the yoke 30, each drive mechanism 38 including a body 42 that follows a closed loop that lies in a plane that is parallel to the drive axis and the translation axis, said body 42 being operatively coupled to the shuttle 24. More particularly, each drive mechanism 38 comprises a pair of rotors 44, namely, gears, spaced apart in the direction of the drive axis and an element 46 that defines the loop and couples the rotors 44 together for co-rotation, namely, a chain, the aforementioned bodies 42 each being one link in the chain that is in receipt of the pintles.

The motor arrangement 26 includes a motor 48 and a pair of chain and gear arrangements 50. The motor 48 has a shaft 52 for each drive mechanism 38. The motor shafts 52 rotate around a common axis that is parallel to the offset axis, each shaft 52 being operatively coupled to the drive mechanism 38 for which it is provided by a respective one of the chain and gear arrangements 50 to drive rotation of the bodies 42 around the loops.

The counterweight arrangement 28 comprises a weight 54, a pair of pulleys 56 and a cable 58, the cable 56 coupling the weight 54 to the yoke 30 to urge the yoke 30 upwardly.

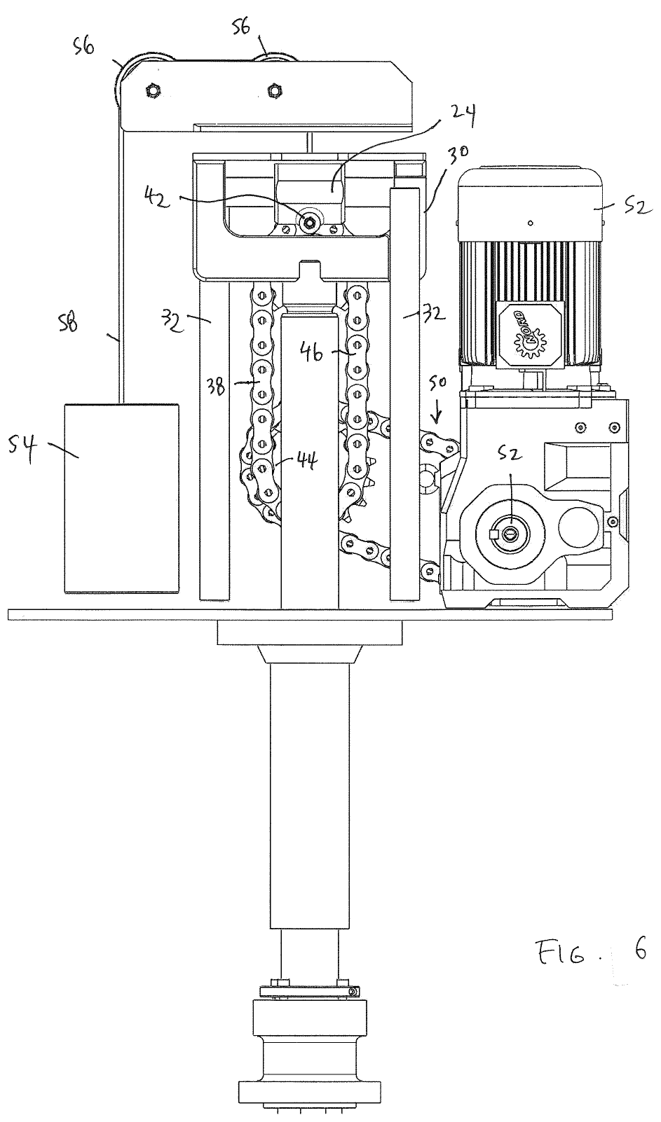

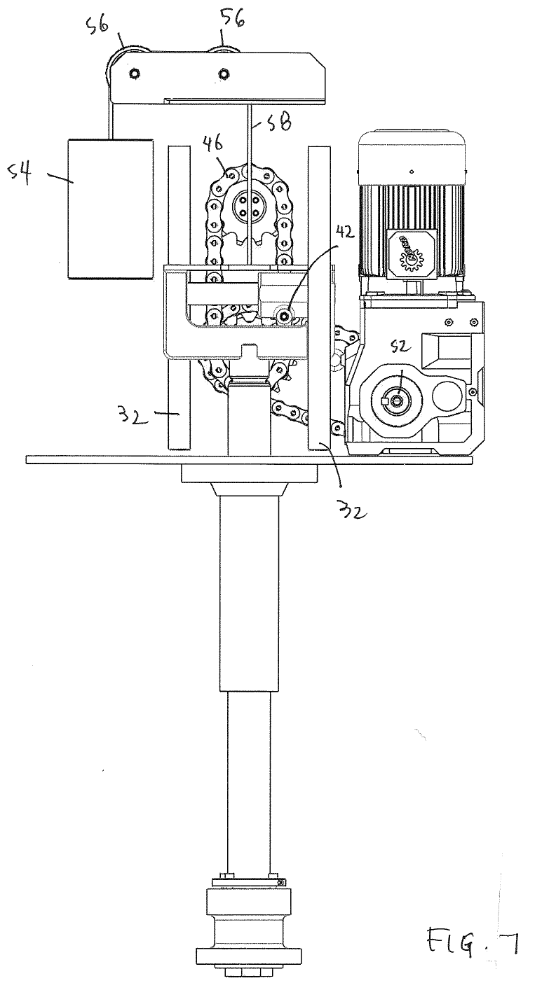

FIGS. 6 through 9 each show body 42 traversing one rotation of the chain of which it forms part.

FIG. 6 shows body 42 at top dead centre.

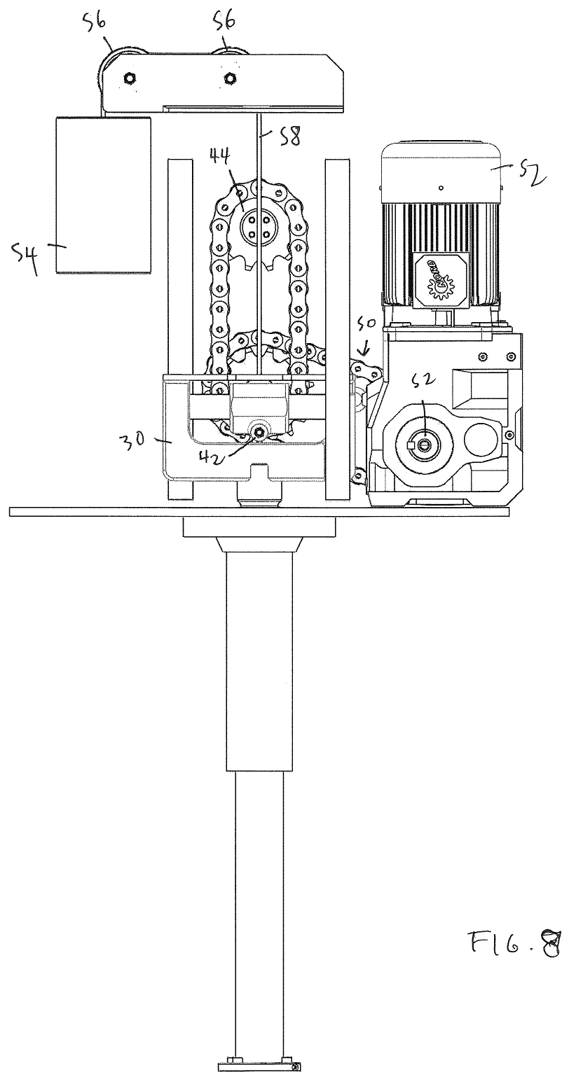

As the gears rotate clockwise, the body 42 travels initially clockwise, then vertically downwardly to its position in 4B. It will be appreciated that, to accommodate such movement, the pintles 36 (which it will be remember, each pass through a body 42) urge the shuttle 24 initially to the right and then downwardly. As the gears continue to rotate clockwise, the pintles 36 initially move downwardly, then clockwise from 3 to 6 o'clock, to the dead bottom position shown in FIG. 8. Again, it will be appreciated that each body 42 has urged its pintle 36 now back to the centre of the yoke 30, and the shuttle 24/bushing with it.

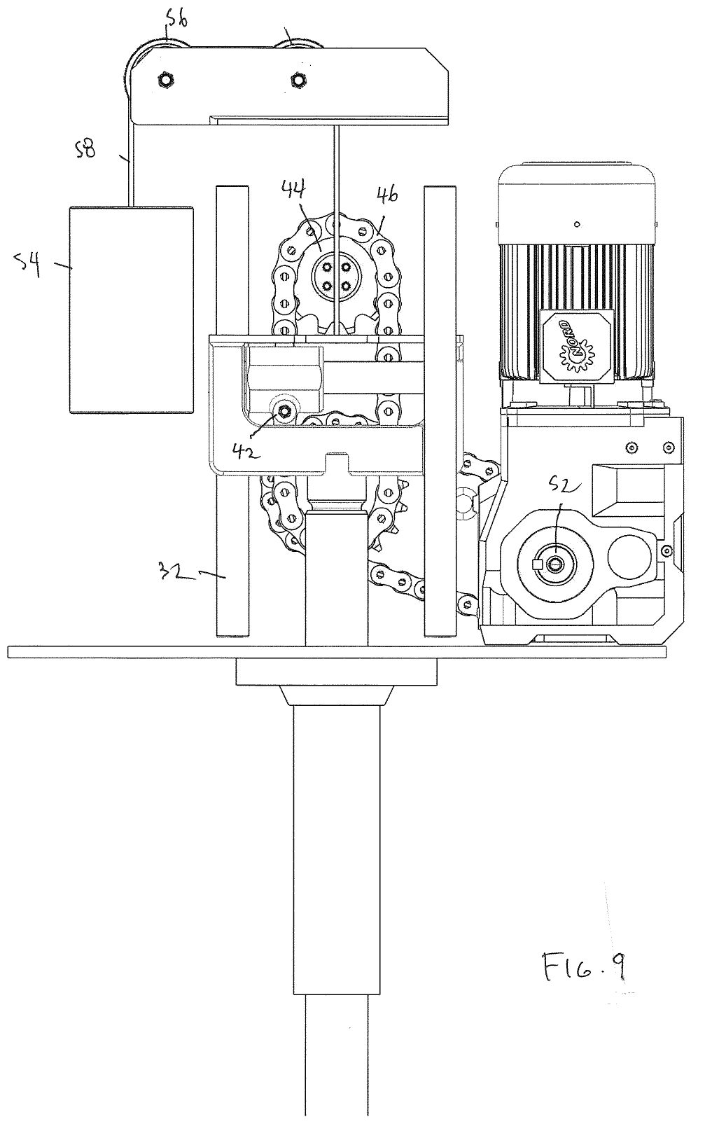

The sequence of FIGS. 9, 6, show the final movements of the shuttle/pin/yoke, back to the end of the complete cycle.

Persons of ordinary skill will readily recognize that the yoke can readily be connected to the drive shaft of a vertical motion mixer, not shown. A suitable mounting flange is illustrated by way of example in FIG. 1 and indicated by general reference numeral 60. The apparatus could also be utilized in other applications where apparatus that is relatively energy efficient, relatively robust, relatively economical to manufacture and relatively easy to maintain is needed to impart reciprocal motion to a workpiece with relatively high force.

Whereas a specific embodiment is shown and described, it will be apparent that variations are possible.

Accordingly, the invention should be understood to be limited only by the accompanying claims, purposively construed.

1. Apparatus comprising:
a assembly defining a drive axis, a translation axis perpendicular to the drive axis and an offset axis perpendicular to both the drive and translation axes, the assembly including a yoke;
a shuttle mounted to the yoke for reciprocating motion along the yoke parallel to the translation axis; and
a pair of drive mechanisms spaced apart from one another in the direction of the offset axis and disposed in flanking relation to the yoke, each drive mechanism including a body that follows a closed loop, said body being operatively coupled to the shuttle to reciprocate the yoke along a path parallel to the drive axis.

2. Apparatus according to claim 1, wherein the loop lies in a plane that is parallel to the drive axis and the translation axis.

3. Apparatus according to claim 2, wherein each drive mechanism comprises a pair of rotors spaced apart in the direction of the drive axis and an element that defines the loop and couples the rotors together for co-rotation.

4. Apparatus according to claim 3, further comprising a motor having a shaft for each drive mechanism, each shaft being operatively coupled to the drive mechanism for which it is provided to drive rotation of the body around the loop.

5. Apparatus according to claim 4, wherein the element is a chain and the rotors are gears.

6. Apparatus according to claim 5, wherein each shaft is operatively coupled to the drive mechanism for which it is provided by a chain and gear arrangement.

7. Apparatus according to claim 6, wherein the motor shafts rotate around a common axis that is parallel to the offset axis.

8. Apparatus according to claim 5, wherein the shuttle terminates in a pair of pins extending from opposite ends, spaced apart from one another in a direction parallel to the offset axis and extending in the direction of the offset axis, each pin engaging a respective chain.

9. Apparatus according to claim 1, wherein the shuttle is a bushing.

10. Apparatus according to claim 1, wherein the means further includes a pair of bearing shafts disposed in parallel flanking spaced relation to the path and the yoke defines, for each shaft, a bushing, said bushing being in receipt of said each shaft.

11. Apparatus according to claim 1, further comprising a weight, a pair of pulleys and a cable, the cable coupling the weight to the yoke to urge the yoke upwardly.
